(19) United States
(12) Patent Application Publication
(10) Pub. No.: US 2001/0024436 A1
(43) Pub. Date: Sep. 27, 2001

(54) Voice-over IP audio-data terminal processor

(76) Inventors: Keith Barraclough, Menlo Park, CA (US); Bryan R. Martin, Campbell, CA (US); Philip Bednarz, Menlo Park, CA (US); Paul Voois, Sunnyvale, CA (US)

Correspondence Address: CRAWFORD PLLC, Suite 390, 1270 Northland Drive, St. Paul, MN, 55120, US

(21) Appl. No.: 09/739,410

(22) Filed: Dec. 18, 2000

Related U.S. Application Data
(60) Provisional application No. 60/172,543, filed on Dec. 17, 1999.

(51) Int. Cl. H04L 12/66; H04L 12/56

(52) U.S. Cl. 370/352; 370/401

(57) ABSTRACT

The present invention is directed to the integration of communications systems using an IP-telephony interface circuit arrangement. In one embodiment, the interface arrangement includes a plurality of audio-endpoint devices adapted to process audio information coupled to respective audio channels, and a data gateway circuit including multiple circuit paths coupled to the respective audio channels. The multiple circuit paths couple to an interface circuit adapted to convert audio information between a first audio-channel format and a second IP-data format, and the data gateway circuit is coupled with a first interface for communicatively coupling the audio information in the second IP-data format to an IP communications link and with a second interface for communicatively coupling the audio information in the first audio-channel format to the plurality of audio-endpoint devices. In this manner, conventional and IP communications are effectively enabled to operate and communicate together.

### RELATED PATENT DOCUMENTS

This nonprovisional application claims priority to, and hereby incorporates, Provisional Application No. 60/172,543, and only to the extent needed for pendency, this is alternatively a conversion of Provisional Application No. 60/172,543, filed on Dec. 17, 1999.

This application is related to U.S. patent application Ser. No. 09/______, entitled “Network Interface Unit Control System and Method Therefor,” filed concurrently herewith (Docket No. 8X8S.223PA), to U.S. patent application Ser. No. 09/662,077, entitled “Voice Over Internet Protocol Processor,” filed Sep. 14, 2000 (Docket No. 8X8S.243PA), and to U.S. patent application Ser. No. 09/005,053, entitled “Videocommunicating Apparatus and Method Therefor”, filed on Jan. 1, 1998, which is a continuation-in-part of U.S. patent application Ser. No. 08/908,826, filed on Aug. 8, 1997 (now U.S. Pat. No. 5,790,712), which is a continuation of U.S. patent application Ser. No. 08/658,917, filed on May 31, 1996 (now abandoned), which is a continuation of U.S. patent application Ser. No. 07/303,973, filed Sep. 9, 1994 (now abandoned), which is a continuation of U.S. patent application Ser. No. 07/838,382, filed on Feb. 19, 1992, (now U.S. Pat. No. 5,379,351), all of which are incorporated herein by reference.

### FIELD OF THE INVENTION

The present invention relates to communication systems, and more particularly, to Internet protocol (IP) audio processing.

### BACKGROUND OF THE INVENTION

For many communication applications, realizing higher-functioning devices in a cost-effective manner requires the creative use of communications channels. Many technologies have been developed that have enhanced communications. Examples include the Internet, facsimile applications, public switched telephone networks (PSTN), wireless telephones, voicemail systems, email systems, paging systems, conferencing systems, electronic calendars and appointment books, electronic address books, and video-image processing systems that communicate video data simultaneously with voice data over a telephones and the Internet. As the popularity of these technologies increases, so does the need to merge and coordinate these technologies in a manner that is convenient and cost-effective for the user.

The growing availability and applicability of the Internet has spawned a growth in the use of communication systems and services offering Internet protocol (IP) telephony. Widespread acceptance and usage of such communication systems and services are largely a function of cost, user convenience and interoperability with other communications systems. Therefore, for these technologies to continue to grow, they must be readily available, cost effective, and easy to use for consumers.

One challenge to the development, use and integration of IP telephony devices and systems is the gap between IP and conventional communications systems and equipment. There is a need to bridge this gap to enable various types of telephones, computers, wireless phones, and other communications devices to communicate with each other. While new communications technologies offer many advantages, there continues to be a need to provide a manner in which devices and systems employing these technologies can interface with conventional devices such as analog phones, modems, and fax machines.

### SUMMARY OF THE INVENTION

The present invention is directed to a communications gateway for controlling and coordinating various types of communications data in a manner that makes possible the break-down of traditional barriers preventing the integration of IP and conventional communications. In addition, the ease of use and cost-effectiveness of the present invention make possible the continued growth and integration of IP-based communications systems and devices for small business and home use. The present invention is exemplified in a number of implementations and applications, some of which are summarized below.

According to an example embodiment of the present invention, an IP-telephony interface circuit arrangement include a plurality of audio-endpoint devices adapted to process audio information coupled to respective audio channels, and a data gateway circuit. The data gateway circuit includes multiple circuit paths coupled to the respective audio channels, and includes an interface circuit adapted to convert the audio information between a first audio-channel format and a second IP-data format. The multiple circuit paths are adapted to process the audio information. The data gateway circuit is configured and arranged with a first interface for communicatively coupling the audio information in the second IP-data format to an IP communications link and with a second interface for communicatively coupling the audio information in the first audio-channel format to the plurality of audio-endpoint devices.

Another example embodiment is directed to a data gateway adapted to convert between IP and analog telephony data. The gateway comprises an IP telephony processor adapted to compress and format audio data for transmission over an IP network; an IP communications port adapted to connect to an IP communications link; and a POTS communications port adapted to connect to a POTS link.

The above summary of the present invention is not intended to describe each illustrated embodiment or every implementation of the present invention. For example, other aspect of the invention are directed to methods and systems that implement and/or use the above circuits and arrangements. The figures and detailed description which follow more particularly exemplify these and other embodiments.

### BRIEF DESCRIPTION OF THE DRAWINGS

The invention may be more completely understood in consideration of the following detailed description of various embodiments of the invention in connection with the accompanying drawings, in which:

FIG. 1 is an example application of communications system having an IP/PSTN gateway, according to an example embodiment of the present invention;

FIG. 2 is an example arrangement of an application in which multiple Voice-over-IP gateway devices serve eight IP appliances, according to another example embodiment of the present invention;

FIG. 3 is an example data-flow arrangement, according to another aspect of the present invention and useful for the communications arrangements of FIGS. 1 and 2; and

FIG. 4 is a block diagram of an example embodiment of a voice-over-IP gateway device, according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to various types of communications, and has been found to be particularly suited to communications devices, systems and networks requiring or benefiting from the integration of IP and conventional telephony equipment. While the present invention is not necessarily so limited, various aspects of the invention may be appreciated through a discussion of various examples using this context.

One example embodiment of the present invention is implemented in the form of a voice-over-IP gateway that can be implemented with relatively a low complexity and that bridges the gap between conventional telephony systems equipment such as telephone and fax machines and the new world of Internet protocol (IP) communications over private networks and the public Internet. In a particular example application, the voice-over-IP (“VoIP”) gateway functionality can be implemented on a single printed circuit board (PCB) for connecting up to four independent calls simultaneously. This PCB is implemented using a CPU arrangement, such as is described in the above-referenced patent document identified by Ser. No. 09/662,077, filed Sep. 14, 2000 (Docket No. 8X8S.243PA). This CPU arrangement is implemented, in one example, as a single chip which provides the DSP and command/control processing for compressing the audio and formatting the call for the data transmission over IP networks. Connection to IP networks can be made via an Ethernet MAC/PHY chip, which provides access to 10BaseT Ethernet and manages flow control. This approach provides a complete solution for connecting existing telephony equipment in homes and small offices to broadband networks, and can be made fully compatible with IEEE 802.3 10BaseT interface.

The above-characterized implementation may use either the SGCP/MGCP or H.323 standards for VoIP, and it can fully compatible with the Cablelabs' “Packet-Cable” initiative, with the emerging H.GCP standard and with Microsoft NetMeeting. The implementation incorporates Non-volatile re-writeable memory (e.g., Flash memory) for remote upgrade capability, so that systems may be programmed with updated protocols via the network.

The VoIP implementation can be implemented in various forms, four of which include: a populated and tested PCB, complete with Codec software for integration directly into a commercially-available product; a unit level assembly which includes the VoIP PCB in a housing; as an evaluation system with hardware and software tools; and as a developer's kit that includes schematic files, layout files, and the software libraries. A set of audio Codec libraries can be supplied for the Symphony board, for examle, in the form of object code. A comprehensive command/control and GUI (graphic-user interface) application can be supplied as source code with the developer's kit, enabling the rapid modification and customization of the design for the ultimate in development flexibility.

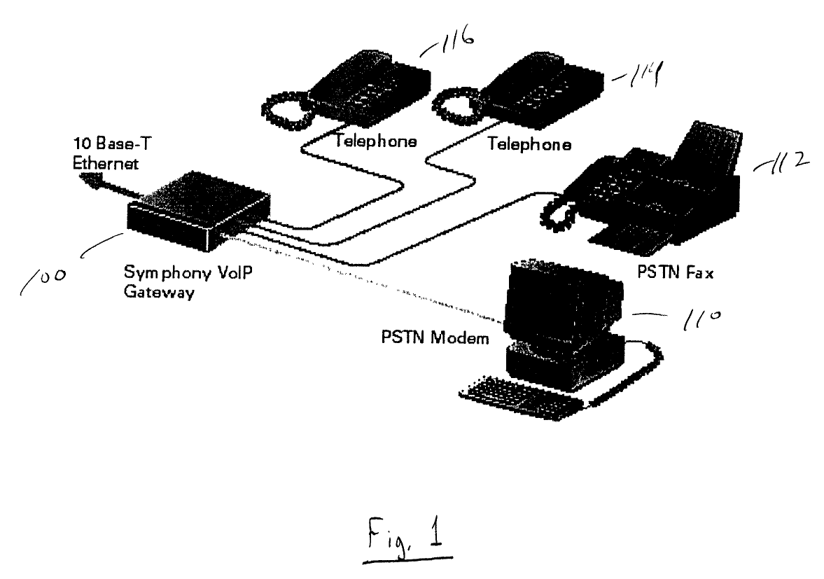

FIG. 1 shows an application for communicating through a VoIP gateway device 100, according to an example embodiment of the present invention. Communicatively coupled to the VoIP gateway device 100 are a PSTN Modem 110, a PSTN Fax machine 112, two telephones 114 and 116. The VoIP gateway device 100 behaves as a four-line telephone switch with a resident Ethernet gateway. The VoIP gateway device 100 supports the features expected from a commercial PSTN switch provider such as: BORSCHT (Battery, Over-voltage, Ringing, Supervision, Codec, Hybrid and Testing), Caller-ID, Three-way calling; Detect DTMF, Call Waiting, Last number redial, and Call Return. The VoIP gateway device 100 also permits the possibility of ringing one of the phones 114, 116 from the other phone 116, 114. A major advantage of the VoIP gateway device 100 is the built-in Ethernet gateway, which facilitates a connection with other gateways via an Internet connection.

According to a more specific embodiment, the VoIP gateway device 100 provides full PSTN compatibility for four lines as indicated in connection with each of the IP appliances (110, 112, 114, 116). The VoIP gateway device 100 gateway includes a CPU arrangement, which can be implemented using the (“Audacity ITP”) chip described in the above-referenced Patent document for coding a high-quality digitized audio stream into a low bit-rate data stream. This CPU arrangement then packetizes the coded audio and provides IP stack support. The resulting data packets can be transmitted easily over an Ethernet connection to the Internet.

By implementing the VoIP gateway device 100 as being able to provide full PSTN compatibility for four lines, the VoIP gateway device 100 provides full PSTN compatibility for four lines can support four PSTN devices simultaneously. These four PSTN devices can comprise any combination of telephone, fax machine, modem or other common PSTN device. The PSTN apparatus can be connected to the VoIP gateway device 100 using U.S. telephony wiring via RJ11 connectors. Non-U.S. Customer-Premise Equipment (CPE) can be attached, using readily available adapters. The VoIP gateway device 100 is connected to a local Ethernet connection via a standard RJ45 connector. A low voltage, dual conductor cable can be used to supply power, for example, via a 1.3 mm jack socket.

Such a VoIP gateway device can also be implemented to support up to 4 CPE, and to ring all four phones simultaneously using non-overlapping ring-signal management. The ringing voltage can be supplied only to one line at any instant. Normal ringing “cadences” allow the ringing of any line to be concurrent with silence on the other lines. Ringing cadence can be changed to allow for various features, such as “Distinctive Ring” and standard national ring patterns.

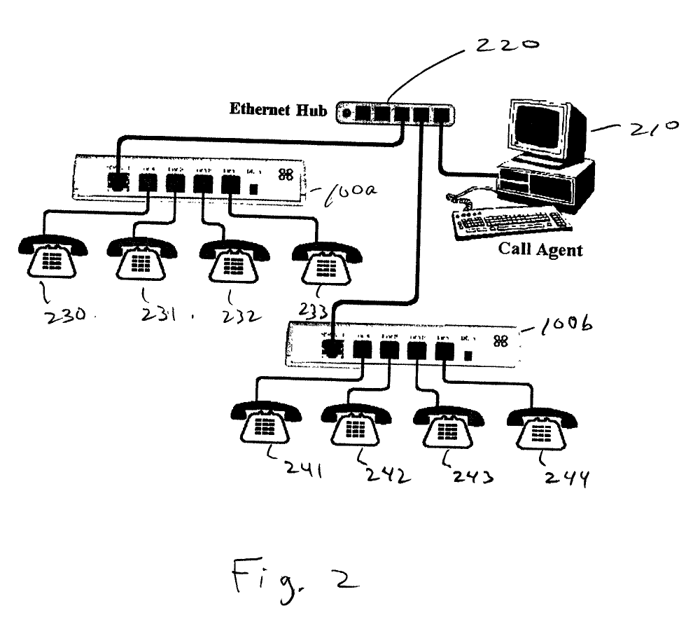

In another example application and as shown in FIG. 2, multiple VoIP gateway devices 100a and 100b can be configured to expand the number of IP appliances served, according to another example embodiment of the present invention. The call agent 210 is a conventional PC programmed to implement call control using the MGCP protocol standard for controlling residential gateways. The Ethernet hub 220 provides the communication path for the multiple VoIP gateway devices 100a and 100b, any other VoIP gateway devices subsequently added to further expand the number of IP appliances served. Each of the illustrated telephones 230-233 and 241-244, respectively connected to VoIP gateway devices 100a and 100b, is a conventional IP telephone as depicted in FIG. 1.

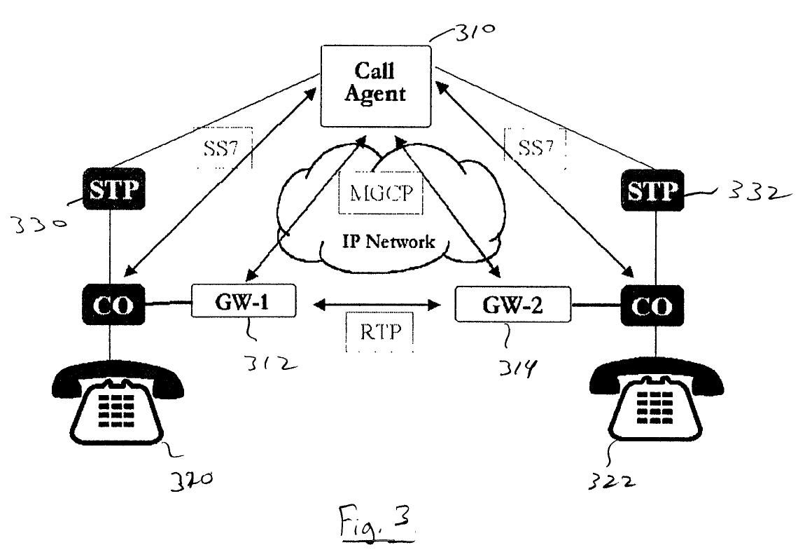

The VoIP gateway device 100 may use either MCGP or H.323 communication standards, depending on the profile and its end use. The MCGP recommendation describes the Media Gateway Control Protocol (MGCP) for use in a centralized call control architecture and assumes relatively simple client devices. As shown in FIG. 3, this protocol can be used for controlling voice-over-IP (VoIP) gateways from external call control elements. MGCP assumes a call control architecture where the call control “intelligence” is outside the gateways and is handled by external call control elements. For example, the call agent 310 of FIG. 3 implements the SS7/ISUP protocol standards and uses MGCP to provide remote-control functionality for the gateways 312 and 314 via the Internet and signal transfer points (“STP”) 330, 332. In this example, application, the gateways 312 and 314 are communicating using a real time protocol (“RTP”) and are coupled to other telephones 320 and 322 via a respectively-coupled CO (central office) which is used to communicatively couple the gateways 312 and 314. For further details, reference may be made to the above-referenced patent document concurrently filed herewith.

The H.323 recommendation describes terminals and other entities that provide multimedia communications services over Packet Based Networks (PBN) that may not provide a guaranteed Quality of Service (“QoS”). H.323 entities may provide real-time audio, video and/or data communications. The PBN, over which H.323 entities communicate, may be a point-to-point connection, a single network segment, or an intern-network having multiple segments with complex topologies. H.323 entities may be used in point-to-point, multi-point, or broadcaset configurations.

The application program for the CPU arrangement includes an audio codec, DTMF tone detection and Acoustic Echo Cancellation (AEC), which are of course conventional building blocks for implementing a VoIP product. For example, one or more of the following audio codecs can be supported: G.711 A-LAW PCM 64 kbs, 8 kHz sampling—8 channels; G.711 μ-LAW PCM 64 kbs, 8 kHz sampling—8 channels; G.723 MPCMLP 6.3 kbs, 8 kHz sampling—4 channels; G.726 ADPCM 16, 24, 32, 40 kbs 8 kHz—4 channels; and G.728 LD-CELP 16 kbs, 8 kHz sample rate—2 channels.

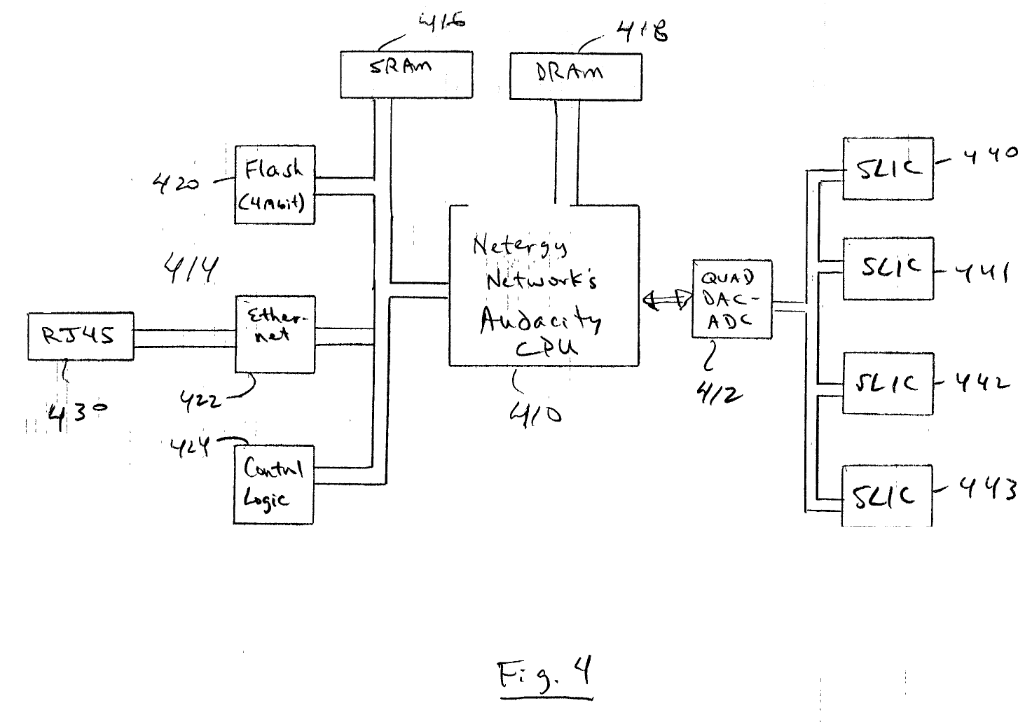

FIG. 4 shows an example architectural block diagram, according to another aspect of the present invention, for implementing a version of the VoIP gateway device (e.g., 100 of FIG. 1). This block diagram illustrates the CPU 410 configured and programmed using the telephony Audacity processor, a memory sub-system including memory blocks 416, 418 and 420, an audio sub-system including a quad A-D/D-A converter 412, I/O sub-system, a quad SLIC interface arrangement 440-443 and related circuitry including control logic 424, and an Ethernet interface arrangement including Ethernet interface 422 and a physical RJ45 interface 430.

Physically, for rack mounting and user-friendly management, the input/output connectors can be located at the back of the PCB which hosts the above blocks, and the indicators for status and user interaction features can be located at the front of the PCB. The input/output connectors can include, for example, four RJ11 connectors for the IP endpoint appliances, one RJ45 connector for the Ethernet connection, and a power supply connector. The indicators for status and user interaction features can include line 1 through 4 status LEDs, Call Agent ready LED, MGCP Line Status LED, and System Status LED. In such an application, system control is achieved using the resident CPU arrangement 410 of FIG. 4.

The CPU arrangement 410 uses three types of memory for program storage, execution and caching of data: FLASH Memory 420; SRAM Memory 416; and DRAM Memory 418.

The SRAM memory 416 is volatile and is used for program storage and execution when in operation. The SRAM memory 416 can be configured as one bank of four IC's. Each IC has eight data bits and 128 k of total storage. When the IC's are mapped together they provide 128 k×32 bits (512 k×8) of contiguous storage area. Each SRAM IC has an asynchronous access speed of 12 nS or better.

The DRAM memory 418 is also volatile and used for general data storage and caching of incoming Ethernet data. The DRAM can be configured as one bank of two IC's. Each IC is sixteen bits wide with 256 k words of total storage. When the IC's are mapped together they provide 256 k×32 bits (1M×8) of contiguous storage area. Each DRAM IC has an access speed of 50 nS or better. Both FPM and EDO DRAM are supported.

The FLASH memory 420 is non-volatile and can be used for remotely programming the VoIP gateway device and for program storage and user settings when the power is off. The Flash memory 420 is configured, e.g., as 512 k×8 bits. For flexible erase and program capability, the 512 kbits of data can be divided into 11 sectors: one 16 kbyte, two 8 kbyte, one 32 kbyte, and seven 64 kbytes.

Also shown in FIG. 4 is an SRAM bus which is used in the VoIP gateway device as a 32 bit parallel bus that runs between the CPU arrangement 410, the SRAM 416, the FLASH memory 420, the Ethernet controller 422, and the control logic 424, e.g., a PAL device. The bus has separate WRITE, READ and four byte ENABLE signals, all active low.

The DRAM bus used in the Symphony Gateway is a 32 bit parallel bus and runs between the Audacity processor and the DRAM. The bus has separate WRITE, READ, RAS, CAS signals, all active low.

The Ethernet controller 422 can be implemented using a Fujitsu MB86964 device. The device supports the 10BaseT and 10Base2 interfaces. The device is mapped onto the SRAM bus.

The logic circuitry (e.g., 424 of FIG. 4) is based on a Lattice Semiconductor core. Lattice can supply a suite of related tools allowing both design and in system programming of this part. For example, one such specific part which can be used an ISPLSI2128V-80LT100, which is a 3.3V I/O part. This Lattice chip is programmed with glue-logic designed to suite the existing profile of the board. However, if the board has a different function of application to meet specific needs, new glue-logic can be used to support the external hardware features from software.

Two dual SLICs can be used to provide the four PSTN ports, two PSTN subscriber lines per SLIC. Each port is identical to a single PSTN subscriber line and can be used in the same way with RJ11 connections. PSTN devices such as telephones, facsimile machines and modems can be connected. The architecture of the PSTN interface can be based upon two dual SLICs feeding a single quad CODEC. Four separate channels can be digitized in this way. As an example, the quad codec used in the design is a Lucent T5504/7504 (U11). It is capable of coding and decoding four channels simultaneously. Two dual SLICs extract the analog audio from the PSTN lines and pass the audio to the quad CODEC. A commercial part that can be used for this purpose is the Lucent L8576.

Coupled to the PSTN connector are a series of components designed to protect both the telephony equipment and the SLIC from undesired operating conditions such as voltage spikes. Much of this conditioning is performed inside the Lucent L7591 SLIC chip, which have resistive impedance, and are best suited for driving short-haul local loops, commonly less than 5000 ft. Each line is capable of supporting the 5000 ft individually. The SLICs are designed with a minimum power dissipation occurring at a local loop length of 500-1000 ft.

To power the CPE (customer premise equipment) attached to the PSTN lines, a battery supply voltage must be present, since CPE devices rely on the local central office to supply power. As the VoIP gateway device performs the role of a small central office, it must provide a standard PSTN power supply to each of the connected devices. Each connector has a REN rating of 5 for short-haul applications, primarily within a home or small office.

A Time Division Multiplexed (TDM) port also coupled to the quad CODEC allows access to the high-speed, bi-directional serial bus which is used to transfer the PCM encoded bit stream between the PCM codec and Audacity ITP. The TDM interface on the Audacity ITP can implement a number of high-speed serial protocols including CHI, GCI, K2, SLD, MVIP and IOM2 formats. The TDM port can also act as a general purpose 16 Mbit/sec serial link.

Relating to each of the above embodiments, other aspects, discoveries, advantages and embodiments realized in connection with the present invention are characterized in the above-referenced patent documents and in the attached appendixes which are respectively entitled, “8×8 Application Note SYMPHONY VoIP ACCESS GATEWAY,” and SYMPHONY INTEGRATOR'S MANUAL, each being incorporated by reference in its entirety.

While the present invention has been described with reference to several particular example embodiments, those skilled in the art will recognize that many changes may be made thereto without departing from the spirit and scope of the present invention, which is set forth in the following claims.

What is claimed is:

1. An IP-telephony interface circuit arrangement, comprising:
a plurality of audio-endpoint devices adapted to process audio information coupled to respective audio channels; and
a data gateway circuit including multiple circuit paths coupled to the respective audio channels, the multiple circuit paths adapted to process the audio information, and including an interface circuit adapted to convert the audio information between a first audio-channel format and a second IP-data format; the data gateway circuit being configured and arranged with a first interface for communicatively coupling the audio information in the second IP-data format to an IP communications link and with a second interface for communicatively coupling the audio information in the first audio-channel format to the plurality of audio-endpoint devices.

2. The IP-telephony interface circuit arrangement of claim 1, wherein the data gateway circuit is configured and arranged to expand service to additional audio-endpoint devices.

3. The IP-telephony interface circuit arrangement of claim 2, wherein the data gateway circuit is configured and arranged to expand service to additional audio-endpoint devices in multiples of 2^{N}, where N is an integer.

4. The IP-telephony interface circuit arrangement of claim 1, wherein the data gateway circuit further includes a pair of dual SLICs for connecting up to four audio-endpoint devices.

5. A data gateway adapted to convert between IP and analog telephony data, the gateway comprising:
an IP telephony processor adapted to compress and format audio data for transmission over an IP network;
an IP communications port adapted to connect to an IP communications link;
a POTS communications port adapted to connect to a POTS link.

6. The data gateway of claim 5, further comprising a PCB having Codec integration software.

7. The data gateway of claim 5, further comprising a unit level assembly including the PCB in a housing.

8. The data gateway of claim 6, wherein the Codec integration software includes libraries supplied as object code.

9. The data gateway of claim 5, further adapted to evaluate a communications system, the gateway further comprising hardware and software tools to effect the evaluation.

10. The data gateway of claim 5, further comprising a developer's kit having communication links, software, hardware, and a programming interlink, the gateway being adapted to couple at least one conventional telephony device to an IP telephony network.

11. The data gateway of claim 5, wherein the gateway is adapted to use communications standards for VoIP.

12. The data gateway of claim 5, wherein the gateway is adapted to interface with Microsoft NetMeeting software.

13. The data gateway of claim 5, wherein the IP telephony processor is adapted to use DSP and command/control processing for compressing and formatting the audio data.

14. The data gateway of claim 5, wherein the IP communications port includes an Ethernet MAC/PHY chip adapted to provide access to 10BaseT Ethernet and manage flow control.

15. The data gateway of claim 5, further comprising a FLASH data memory for remotely programming the data gateway.

16. The data gateway of claim 5, further comprising a data memory that includes at least one of: FLASH memory, SRAM memory, and DRAM memory.

17. The data gateway of claim 5, wherein the IP telephony processor is remotely programmable.

18. The data gateway of claim 5, further adapted to control a plurality of telephony calls simultaneously using a ring management process.

19. The data gateway of claim 5, wherein the IP communications link includes a broadband link.

20. An IP telephony communications system comprising:
a data gateway adapted to convert between IP telephony data and POTS telephony data;
an IP communications link coupled to the data gateway and to an IP communications network; and
a POTS link coupled to the data gateway and to a POTS communications network.
